(19) United States
(12) Patent Application Publication
(10) Pub. No.: US 2008/0166281 A1
(43) Pub. Date: Jul. 10, 2008

(54) Methods for Producing Cesium Hydroxide Solutions

(76) Inventors: Gerd J. Harms, Goslar (DE); Alexander Schiedt, Hahausen (DE); Manfred Bick, Oberursel (DE); Wolfgang Hildebrandt, Langelsheim (DE)

Correspondence Address: FULBRIGHT & JAWORSKI, LLP, 666 FIFTH AVE, NEW YORK, NY, 10103-3198, US

(21) Appl. No.: 11/795,855

(22) PCT Filed: Jan. 25, 2006
(86) PCT No.: PCT/EP2006/000634

§ 371 Date: Nov. 1, 2007

(30) Foreign Application Priority Data
Jan. 27, 2005 (DE) 102005003999.5

(51) Int. Cl. B01D 11/00

(52) U.S. Cl. 423/202

(57) ABSTRACT

Methods for producing cesium hydroxide solutions during which: cesium-containing ore is disintegrated with sulfuric acid while forming a cesium aluminum sulfate hydrate, which is poorly soluble at low temperatures; the formed cesium alum is separated away in the form of a solution from the solid ore residues; the aluminum is precipitated out of the cesium alum solution while forming a cesium sulfate solution; the formed cesium sulfate solution is reacted with barium hydroxide or stontium hydroxide while forming a cesium hydroxide solution, and; the formed cesium hydroxide solution is concentrated and purified.

The invention relates to a process for the production of caesium hydroxide solutions.

Current processes for the production of caesium compounds are based on caesium-containing ores such as pollucite. Thus U.S. Pat. No. 6,015,535 describes a process for the production of concentrated and purified caesium salt solutions. This process includes the digestion of the ore with a hyperstoichiometric quantity of sulfuric acid, the purification by recrystallisation of the caesium aluminium sulfate hydrate obtained in this way, the precipitation of the aluminium with slurried lime Ca (OH)₂ and/or calcium carbonate and the separation of the precipitate consisting of calcium sulfate hydrate (gypsum) and aluminium hydroxide from the caesium sulfate solution. There follows a reaction of this solution with a calcium hydroxide slurry and an acid, maintaining a pH of 7 to 8. Separation of the residue consisting of calcium sulfate from the caesium salt solution determined by the anion of the acid then takes place. Purification of the caesium salt solution takes place by a multi-stage “polishing” in which the solution is rendered alkaline with barium hydroxide and then mixed with carbon dioxide or carbonate, alkaline earths and sulfate being precipitated and separated off. The by then highly dilute caesium salt solution is finally concentrated by evaporation, wherein concentration can continue until a solid is obtained.

Patent DE 43 13 480 C1 describes the production of a caesium hydroxide solution by reacting caesium aluminium sulfate hydrate or a caesium sulfate solution with calcium hydroxide in accordance with the equations

CsAl(SO₄)₂ +2Ca(OH)₂ →CsOH+Al(OH)₃↓+2CaSO₄↓ (1)

Cs₂SO₄+Ca(OH)₂→2CsOH+CaSO₄↓ (2)

The yields achieved, however, are very unsatisfactory. U.S. patent application 2002/0143209 A1 attempts to remedy this by repeating the reaction according to equation (2) several times, the caesium hydroxide produced and present in a mixture with caesium sulfate in each case being neutralised with the desired acid.

Due to the comparatively better solubility of the hydroxide of the barium but very low solubility of the sulfate, the reaction

Cs₂SO₄+Ba(OH)₂→2CsOH+BaSO₄↓ (3)

is virtually completely displaced towards the caesium hydroxide. U.S. Pat. No. 3,207,571 describes the reaction of a caesium sulfate solution with an aqueous barium hydroxide solution. A dilute caesium hydroxide solution which is separated from the solid barium sulfate, is obtained. This solution can be converted directly with acid to the corresponding caesium salt solution, or a carbonate solution is produced from this solution by addition of CO₂, wherein excess barium can be precipitated from this as barium carbonate by concentrating and separated.

The processes described have a number of disadvantages. According to the route proposed in U.S. patent application 2002/0143209 A1, caesium hydroxide can only be produced in mixture with other caesium salts. The production method stated in U.S. Pat. No. 3,207,571 leads to highly dilute caesium hydroxide solutions with high, not defined, contents of sulfate and/or barium or has a caesium carbonate solution as the end product. This process does not give caesium hydroxide solutions.

Caesium hydroxide solutions have numerous applications, e.g. as catalysts, and are used as the starting product for the production of all neutral and basic caesium salts and of solid caesium hydroxide and other caesium compounds. Because a disadvantageous purification of the compounds is often not possible or possible only with great expense, a high purity of the caesium hydroxide solutions is desired. Furthermore, a high concentration of the caesium hydroxide solutions is aimed for.

The problem of the present invention is to overcome the disadvantages of the prior art and develop a process for the production of an aqueous caesium hydroxide solution which has a caesium hydroxide concentration of at least 45 wt. % and is marked by as low as possible a content of multivalent cations in general and alkaline earth cations in particular, and low contents of sulfate and carbonate.

The problem is resolved by a process for the production of caesium hydroxide solutions in which
caesium-containing ore is digested, forming a caesium aluminium sulfate hydrate (caesium alum), poorly soluble when cold, with sulfuric acid,
the caesium alum formed is separated off as a solution from the solid ore residues,
the aluminium is precipitated out from the caesium alum solution, forming a caesium sulfate solution,
the caesium sulfate solution formed is reacted with barium hydroxide or strontium hydroxide, forming a caesium hydroxide solution (this process step is described as “causticisation”) and
the caesium hydroxide solution formed is concentrated and purified.

In the reaction of the caesium sulfate solution formed to the caesium hydroxide solution, the use of barium hydroxide is preferred.

Any caesium-containing ore or material can be used as caesium-containing ore. However, pollucite is preferably used. A preferred pollucite has a caesium content of 20 to 24 wt. %. The particle size of the ore used is preferably 90 wt. %, <100 μm and is optionally achieved by grinding the ore.

The following reaction equation can be given for the digestion reaction:

2CsAlSi₂O₆H₂O+4H₂SO₄+18H₂O→2CsAl(SO₄)₂12H₂O+4SiO₂↓ (4)

Digestion is preferably carried out with a hyperstoichio-metric quantity of sulfuric acid (relative to the quantity of ore used). The mixture ratio of caesium-containing ore (with a Cs content of 20 to 24 wt. %): water : concentrated sulfuric acid is preferably=1.0:(1.0 to 1.8):(1.0 to 1.8), particularly preferably 1.0:(1.2 to 1.6):(1.2 to 1.6) and especially preferably 1.0:(1.3 to 1.5):(1.3 to 1.5).

Digestion is preferably carried out in such a way that the mixture of caesium-containing ore, water and sulfuric acid is heated for a period of at least 2 hours at a temperature of >90° C. A digestion time of at least 3 hours is preferred. The preferred minimum temperature is 100° C., particularly preferably 120° C. A preferred maximum temperature corresponds to the boiling point of the reaction mixture. Potentially evaporating water is preferably replaced. The reaction can also be carried out at excess pressure, e.g. at 0.5 to 6 bar excess pressure, preferably 1 to 6 bar excess pressure.

Should the caesium-containing ore also not have a high enough aluminium content or should not enough aluminium be digested during digestion and pass into solution, in a preferred embodiment of the process aluminium can be added in the form of aluminium sulfate during or after digestion, so that a sufficiently high quantity of aluminium is available for the formation of the caesium alum. Without a sufficient quantity of aluminium, yield losses could occur, but performance of the process as such is not affected by an insufficient quantity of aluminium. The molar ratio of Al to Cs is preferably at least 1:1. A slight aluminium excess is particularly preferably used, the Al:Cs molar ratio being up to 1.5:1.

At the end of the digestion reaction and cooling of the reaction mixture, a caesium aluminium sulfate hydrate heavily contaminated by other alkali elements crystallises out. Water or process solutions from later process steps (e.g. mother liquors from the subsequent separation of the Cs alum and/or subsequent crystallisation) are preferably added to the reaction mixture to improve the rate and completeness of crystallisation. The quantity of water or quantity of process solution added is preferably at least 1.2 parts by weight per part by weight of ore used.

The acid excess is preferably separated off at the end of the reaction and cooling of the reaction mixture and optionally dilution of the reaction mixture. Separation can be carried out e.g. by decanting, filtering or centrifuging. The acid excess separated off can be used again for the next digestion, optionally after concentrating. The mixture ratios cited include the content of returned acid.

Separation of the caesium alum formed from the solid ore residues can preferably be carried out as follows:

The reaction mixture is slurried in water and/or process solutions with stirring and heated to a temperature of >80° C. The preferred minimum temperature is 95° C., particularly preferably 100° C. A preferred maximum temperature corresponds to the boiling point of the reaction mixture.

Potentially evaporating water is preferably replaced. Dissolution can be carried out even at excess pressure, e.g. at 0.5 to 6 bar excess pressure, preferably 1 to 6 bar excess pressure. The hot solution of the caesium alum is then separated from the ore residues; separation can take place e.g. by decanting, filtering or centrifuging. This process is preferably repeated several times in order to separate the caesium alum as completely as possible from the ore residues. The hot caesium alum solution can be transferred to another reactor.

Alternatively, the process can be carried out in such a way that the dissolved caesium alum is separated together with the sulfuric acid from the ore residue after digestion before cooling. The caesium alum can then be crystallised out from the digestion acid (sulfuric acid). Particular materials are thereby required because of the highly corrosive action of the hot solution.

In a preferred variant of the process, solid caesium alum is crystallised out from the caesium alum solution freed of the solid ore residues, by cooling and particularly preferably purified by recrystallisation.

Recrystallisation can be repeated once or several times. In particular, the impurities of other alkali metal compounds are thereby removed. The mother liquors from recrystallisation can be used again as process solutions further on in the process. Mother liquors with too high contents of alkali metal salts are preferably discarded.

The caesium alum is thereby dissolved with heating in a quantity of water sufficient to dissolve all of the salt and then cooled to approx. 20° C., the supernatant mother liquor being separated off and optionally used again at another point in the process. This recrystallisation is preferably carried out several times. The first recrystallisations can thereby be carried out with mother liquors and the other recrystallisations with water, preferably deionised water (DI water).

Surprisingly it was found that with e.g. six recrystallisations and the use of the mother liquors in the 1^{st}, 2^{nd} and 3^{rd} recrystallisations and carrying out the 4^{th}, 5^{th} and 6^{th} recrystallisation with deionised water (DI water), the contents of for example Rb can be reduced to <10 ppm, based on the content of caesium alum calculated as caesium hydroxide. Preferably, based on the ore charge, 3 to 4 parts by weight DI water are used in the corresponding recrystallisation step.

In some cases, ultrapure water with a specific resistance of >10 MΩ can be used for recrystallisations. This is the case in particular if the content of radioactive cations such as ⁸⁷Rb or ¹³⁷Cs coming from natural and anthropogenic sources is to be reduced.

In the next process step, separation of the aluminium from the caesium aluminium sulfate hydrate (caesium alum) takes place by precipitation of solid aluminium hydroxide using a base, for example calcium hydroxide, for which the following reaction equation can be given:

2CsAl (SO₄)₂12H₂O+3Ca(OH)₂→Cs₂SO₄+2Al(OH)₃/3[CaSO₄x H₂O]↓+(24−x) H₂O (5)

In principle, any basic compound with which in the reaction mixture a pH suitable for the precipitation of aluminium hydroxide can be set (eq. (6)) can be used for precipitation of the aluminium hydroxide. A suitable pH is between 4 to 9, preferably 7 to 8.

2CsAl(SO₄)₂12H₂O+6Ba(OH)→Cs₂SO₄+2Al(OH)₃+3Ba₂SO₄[↓]+24H₂O (6)

One or more of the hydroxides, carbonates or hydrogen carbonates of elements of the 1^{st} and 2^{nd} main groups of the periodic system are preferably used as basic compounds, but they are not restricted to these. As pure as possible a caesium sulfate solution, i.e. a solution that contains as low as possible a content of the sulfate of the base used, is the better to produce, the lower the solubility of this sulfate compound. This is the case in particular with the sulfates of the alkaline earth elements calcium, strontium and barium, slaked lime (calcium hydroxide) or even lime (calcium carbonate) preferably being used for economic reasons.

The reaction is carried out in aqueous solution in such a way that caesium alum and the basic compound (e.g. slaked lime or lime) are caused to react with one another, so that at the end of the reaction, the reaction mixture containing a caesium sulfate solution, aluminium hydroxide and the sulfate of the added base (e.g. gypsum) has a pH of 4 to 9, preferably 6.5 to 7.5. It is advantageous to bring the caesium alum into solution before the reaction. The reaction is carried out particularly preferably at a temperature of >60° C., especially preferably at 90 to 110° C. For example, a saturated solution of caesium aluminium sulfate (caesium alum) heated to a temperature of ≧100° C. can be used and reacted with a suspension of slaked lime or lime with thorough mixing until the desired pH is achieved.

In order on the one hand to achieve as complete as possible a reaction and on the other to improve the filterability of the precipitate, the reaction mixture can preferably be boiled for a period of at least 1 hour with stirring at a temperature of ≧100° C. This process variant has the advantage over the procedure described in U.S. Pat. No. 3,207,571 (addition of caesium alum to a lime suspension) that the basic compound used is reacted virtually completely and the formation of a precipitate layer on the particles of the basic compound used (e.g. calcium hydroxide) is avoided.

Furthermore, it was found that using slaked lime (calcium hydroxide), calcium sulfate hemihydrate (x=0.5 in eq. (5)) and not—as assumed in U.S. Pat. No. 6,015,535—calcium sulfate dihydrate (x=2 in eq. (5)) is formed under the reaction conditions described, which leads to a reduction in the mass of precipitate to be separated.

The conventional processes of solid-liquid separation corresponding to the prior art are used for separating the caesium sulfate solution. For selection it should in particular be considered that the X-amorphous aluminium hydroxide obtained with the production route described is very difficult to dewater and wash.

The caesium sulfate solution produced in the way described can, for example, due to a high dilution, have comparatively low contents of caesium, namely as a rule <5 wt. %, predominantly 2.5 to 3.0 wt. %. The high dilution can therefore mean that e.g. during recrystallisation 2 to 3 times the quantity by weight of water is added to the caesium alum, that e.g. the basic compound (precipitating agent, e.g. slaked lime) is added as suspension of the caesium alum solution, and that e.g. in any purification operations optionally undertaken wash solutions are combined with the first filtrate.

In a preferred variant of the process according to the invention, the caesium sulfate solution obtained is concentrated. This can take place e.g. by evaporating. The solution is preferably concentrated to a content of 20 to 70 wt. %, particularly preferably 40 to 60 wt. % caesium sulfate. Surprisingly it was found that any impurities still present (e.g. Mg, Ca, Sr, Ba) are precipitated out. The purification effect can be improved by adding activated carbon to the solution as a filtering aid. The added quantity of activated carbon is preferably 0.5 to 5 wt. %, particularly preferably 1 to 1.5 wt. %, based on the dissolved quantity of caesium sulfate. In this way, caesium sulfate solutions, the impurities of alkaline earth elements of which, based on the content as caesium sulfate, have the following values: Mg≦0.25 wt. %, Ca≦0.1 wt. %, Sr≦0.01 wt. % and Ba≦0.01 wt. %, are obtained.

The caesium sulfate solution obtained is converted to a caesium hydroxide solution in the next process step. The stoichiometric reaction of a caesium sulfate solution to a caesium hydroxide solution can be carried out in principle with any base M(OH), provided that the difference in the solubilities of the base M(OH) and the corresponding sulfate M₂SO₄ is large enough and consequently the equilibrium according to equation (7) is displaced to a sufficient extent towards the products CsOH and M₂SO₄:

Cs₂SO₄+2M(OH)→2CsOH+M₂SO₄↓ (7)

The caesium sulfate solution is reacted (preferably stoichiometrically) with barium hydroxide or strontium hydroxide (barium hydroxide is preferred). A caesium hydroxide solution is thereby formed. The precipitated barium or strontium sulfate and other poorly soluble impurities produced during this resalting (“causticisation”) (e.g. chromium, iron and/or magnesium hydroxide) are separated in a known way. A caesium hydroxide solution is obtained.

Causticisation can be carried in such a way that a quantity of barium hydroxide corresponding stoichiometrically to the content of the caesium sulfate solution is produced as a suspension, the ratio by weight of barium hydroxide in the form of the monohydrate to water being 1:(1.5 to 4), preferably 1:2.0, this suspension being heated to a temperature between 80 and 100° C., preferably between 95 and 100° C., and then added with intensive mixing tof the caesium sulfate solution also heated to a temperature between 80 and 100° C., preferably between 95 and 100° C. From experience, the contents of the caesium sulfate solution can vary, so that it has proved useful to have a test method for determining the equivalence point of the reaction according to eq. (7).

Two test solutions are produced for this test method, one solution being a carbonate-containing caesium solution, preferably a caesium hydrogen carbonate solution, and the other test solution a barium salt solution. The test is then carried out so that a sample of the reaction mixture is freed of the solid content and in each case part of the solution is mixed with the test solutions. The equivalence point is determined from the visually assessed or even measured turbidity of the mixture of the test solutions with the reaction solutions.

The crude caesium hydroxide solution produced in the way described above is greatly diluted with a concentration between 1 and 5 wt. % and can contain a number of impurities, for example strontium, calcium, barium and sulfate, the solubility of barium sulfate in caesium hydroxide solutions of higher concentration surprisingly increasing. The crude, dilute caesium hydroxide solution can preferably be even further purified. This can occur by one or more of the following process steps.

At the end of the precipitation reaction described above (in which the caesium sulfate solution reacts with Ba(OH)₂ or Sr(OH)₂), another base (preferably Ba(OH)₂ or Sr(OH)₂) can be added to the mixture of caesium hydroxide solution and precipitated sulfates obtained; this addition to the reaction mixture preferably takes place when it is still hot at between 80 and 100° C., preferably between 95 and 100° C. The addition quantity of this base is—based on the quantity of caesium hydroxide—preferably 0.7 to 3.5 wt. % and especially preferably 1.5 to 2.5 wt. %. After cooling the suspension, the precipitated barium or strontium sulfate and poorly soluble impurities produced are then separated from the caesium hydroxide solution as described above.

Carrying out causticisation is not restricted to the temperature range given but can take place at corresponding excess pressure even at higher temperatures.

The caesium hydroxide solution obtained can be concentrated e.g. by evaporating, e.g. to a CsOH content of 10 to 80 wt. %, preferably 45 to 55 wt. %. Very finely divided solids (e.g. carbonates and/or hydroxides) which can be separated off according to the prior art, are thereby possibly formed. Activated carbon can be used as a filter aid in separation.

The caesium hydroxide solution obtained (a concentrated caesium hydroxide solution is preferred) can be mixed with carbon dioxide or a carbonate or hydrogen carbonate soluble in the hydroxide solution, preferably of the alkali metals, particularly preferably of caesium. The quantity of carbon dioxide to be used is (in each case based on 1000 kg caesium hydroxide) between 2.5 to 10 kg, preferably between 3 and 6 kg and especially preferably between 4 and 4.5 kg; the additions of carbonate or hydrogen carbonate correspond to the addition of carbon dioxide and should be converted accordingly. The precipitation products obtained, possibly very finely-divided, are separated from the solution in a known way. Activated carbon can thereby be used as a filter aid.

Using one or more of these optional process steps, it is possible to obtain caesium hydroxide solutions that have a preferred concentration of 45 to 55 wt. % CsOH. The impurities have, in each case based on the content of anhydrous caesium hydroxide: multivalent cations (e.g. Al, Fe, Cr, Mn) in total ≦20 ppm, individually ≦5 ppm; alkaline earth cations Mg ≦2 ppm, Ca≦10 ppm, Sr≦5 ppm, Ba≦15 ppm; alkali cations Li≦10 ppm, Na≦200 ppm, K≦300 ppm, Rb≦10 ppm; chloride≦200 ppm; SiO₂≦50 ppm; P₂O₅≦5 ppm; sulfate≦100 ppm; carbonate as CO₂≦0.5 wt. %.

Another advantage of the process according to the invention is that the solids produced and separated off in the named process steps which have a not inconsiderable content of caesium compounds, can be used again within the process at a suitable point and consequently the loss of caesium in the overall process can be minimised. The reaction of the caesium sulfate solution to the caesium hydroxide solution and/or the digestion of the ore can be cited as suitable points for the use of the solids.

The subject matter of the invention is explained in greater detail by means of the following examples:

### EXAMPLE 1

A solution consisting of 328 ml deionised water (DI water) and 186 ml 96% sulfuric acid was placed in a 1 l glass flask and 219 g ground pollucite ore added to it with stirring. The reaction mixture was heated and refluxed for 4 hours. During cooling to room temperature, the reaction mixture was diluted with 350 ml DI water. The caesium alum formed was separated from the supernatant acid together with the ore residue using a Nutsch filter and washed acid-free three times with in each case 100 ml DI water. The solid was then transferred to a 1 l beaker and dissolved in 700 ml DI water. The hot solution was filtered using a glass-fibre filter into a 2 l beaker and the filter residue washed twice with in each case 500 ml hot DI water, starting and wash solutions being combined. The solutions were cooled to room temperature with stirring. After the stirrer and sedimentation of the alum were stopped, the supernatant mother liquor was decanted. The caesium alum was recrystallised in 850 ml DI water and the mother liquor decanted; recrystallisation was repeated five times.

The caesium alum purified in this way was dissolved in 500 ml DI water with heating. In another beaker, a suspension of 150 ml DI water and 40 g calcium oxide with a low water content which was added to the caesium alum solution with stirring in the boiling heat until the reaction mixture had a pH of approx. 6.5, was produced. After briefly boiling, the mixture was cooled until it had reached a temperature of approx. 40° C. The suspension was filtered using a fluted filter and washed three times with 100 ml approx. 40° C. hot DI water. The solutions were combined and concentrated to a volume of 65 ml, 800 mg activated carbon were stirred in and the solution freed of solid contents using a Nutsch filter.

Analysis of the sulfate solution obtained in this way gave the values shown in the table, the contents of elements being based on the content of caesium sulfate:

| Test item | Test value | |
|---|---|---|
| Content of Cs₂SO₄ | 50.3 | wt. % |
| Li | 0.3 | ppm |
| Na | 65.0 | ppm |
| K | 110.0 | ppm |
| Rb | 4.0 | ppm |
| Ca | 525.0 | ppm |
| Mg | 0.11 | wt. % |
| Sr | 22.0 | ppm |
| Ba | 3.3 | ppm |
| Al | 0.3 | ppm |
| Cl | 51.0 | ppm |

### EXAMPLE 2

150 ml of the 50% caesium sulfate solution produced in example 1 were diluted with DI water to 2500 ml and heated under reflux to boiling. A suspension consisting of 75 g barium hydroxide monohydrate and 200 g DI water was heated in a beaker to approx. 95° C. and 265 g of the suspension of the hot dilute caesium sulfate solution added with intensive stirring at the boiling point. A small sample of the reaction mixture was taken and filtered and in each case half of the clear solution was mixed with a few drops of a caesium hydrogen carbonate solution or a barium salt solution. The reaction was carried out stoichiometrically with equal turbidity of both solutions. 6 g of the barium hydroxide suspension were once again added and the reaction mixture cooled to 40° C. and filtered using a fluted filter. The filter residue was washed six times with in each case 100 ml 40 to 50° C. hot DI water and all solutions were combined and then concentrated to a volume of 120 ml and cooled to room temperature. 2.2 g caesium carbonate in the form of a 50% solution and 1:5 g activated carbon were added with stirring and then the caesium hydroxide solution filtered using a Nutsch filter. Analysis of the 50% caesium hydroxide solution obtained in this way gave the following values (in each case based on the caesium hydroxide content).

| Test item | Test value | |
|---|---|---|
| Content of CsOH | 51.0 | wt. % |
| Li | 0.25 | ppm |
| Na | 76.0 | ppm |
| K | 108.0 | ppm |
| Rb | 3.3 | ppm |
| Ca | 0.5 | ppm |
| Mg | 0.2 | ppm |
| Sr | 2.0 | ppm |
| Ba | 8.0 | ppm |
| Al | 0.6 | ppm |
| Fe | 0.2 | ppm |
| Cr | 0.3 | ppm |
| Mn | 0.1 | ppm |
| Sulfate | 15.0 | ppm |
| Cl | 59.0 | ppm |
| SiO₂ | 11.0 | ppm |
| P₂O₅ | 0.6 | ppm |
| Carbonate calculated as CO₂ | 0.18 | wt. % |

1-30. (canceled)

31. A process comprising preparing a cesium hydroxide solution by digesting a quantity of cesium-containing ore with sulfuric acid or forming a cesium aluminum sulfate hydrate which poorly soluble when cold, separating the cesium alum formed from solid ore residues as a solution from the digested ore of cesium alum, precipitating the aluminum from the cesium alum solution to form a cesium sulfate solution, reacting the cesium sulfate solution with barium hydroxide to form a cesium hydroxide solution, and concentrating and purifying the cesium hydroxide solution.

32. A process according to claim 31, wherein the cesium sulfate solution formed is reacted with the barium hydroxide.

33. A process according to clam 31, wherein the cesium-containing ore is pollucite.

34. A process according to claim 31, wherein the cesium-containing ore has a cesium content of 20 to 24 wt. %.

35. A process according to claim 31, wherein the cesium-containing ore has a particle size of 90 wt. %, <100 μm.

36. A process according to claim 31 wherein the digestion is carried out with a hyperstoichiometric quantity of sulfuric acid relative to the quantity of the ore.

37. A process according to claim 34, wherein during digestion the mixture ratio of cesium-containing ore to water to concentrated sulfuric acid is=1.0:(1.0 to 1.8)(1.0 to 1.8).

38. A process according to claim 37, wherein the mixture ratio is 1.0:(1.2 to 1.6):(1.2 to 1.6).

39. A process according to claim 37, wherein the mixture ratio is 1.0:(1.3 to 1.5):(1.3 to 1.5).

40. A process according to claim 31, wherein digestion is carried out by heating the mixture of cesium-containing ore, water and sulfuric acid for a period of at least 2 hours at a temperature of >90° C.

41. The process according to claim 40, wherein the digestion period is at least 3 hours.

42. A process according to claim 40, wherein the minimum temperature is 100° C.

43. A process according to claim 42, wherein the minimum temperature is 120° C.

44. A process according to claim 31, wherein the maximum digestion temperature corresponds to the boiling point of the reaction mixture.

45. A process according to claim 31, wherein an evaporated water is replaced during digestion.

46. A process according to claim 31, wherein the digestion reaction is carried out at excess pressure.

47. A process according to claim 46, wherein the excess pressure is 0.5 to 6 bar.

48. A process according to claim 46, wherein the excess pressure is 1 to 6 bar.

49. A process according to claim 31, wherein the aluminum sulfate is added during or after digestion of the reaction mixture.

50. A process according to claim 49, wherein the molar ratio of Al to Cs is at least 1:1.

51. A process according to claim 49, wherein the aluminum sulfate is added in an amount such that aluminum is added in excess relative to the cesium present and the molar ratio of Al to Cs is at most 1.5:1.

52. A process according to claim 31, wherein after digestion the reaction mixture is cooled and water or a process solution from a subsequent process step is added during the crystallization of cesium aluminum sulfate hydrate (cesium alum).

53. A process according to claim 52, wherein the quantity of water or quantity of process solution added is at least 1.2 parts by weight per part by weight of ore used.

54. A process according to claim 31, wherein excess acid is separated off at the end of the digestion reaction and cooling of the reaction mixture.

55. A process according to claim 31, wherein the reaction mixture obtained after separation of the acid excess is scurried in water or process solution at a temperature of at least 80° C. to separate the cesium alum formed from the solid ore residue and the hot solution containing cesium alum is separated from the ore residue.

56. A process according to claim 31, wherein after digestion and before cooling of the reaction mixture the dissolved cesium alum together with the sulfuric acid is separated from the ore residue.

57. A process according to claim 56, wherein the cesium alum is crystallized out from the separated solution containing cesium alum and digestion acid.

58. A process according to claim 31, wherein solid cesium alum is crystallized out from the cesium alum solution freed of the solid ore residues by cooling.

59. A process according to claim 58, wherein the cesium alum is purified by recrystallization.

60. A process according to claim 59, wherein the mother liquor from recrystallization is recycled in the process as a process solution.
